(19) United States
(12) Patent Application Publication
(10) Pub. No.: US 2011/0031653 A1
(43) Pub. Date: Feb. 10, 2011

(54) Railing System

(76) Inventor: Kevin Philip George Hebert, Surrey (CA)

Correspondence Address: Richard D. Okimaw, 210-347 Leon Avenue, Kelowna, BC, V1Y8C7, CA

(21) Appl. No.: 12/461,189

(22) Filed: Aug. 4, 2009

(51) Int. Cl. B29C 51/00; E04H 17/14

(52) U.S. Cl. 264/319; 256/59

(57) ABSTRACT

Disclosed is a railing panel and a method of forming the panel. The panel comprises a planar member extending between first and second ends defining a panel plane. The railing panel further has a hand railing integrally thermoformed with the planar member along a top edge thereof and a bottom rail integrally thermoformed with the planar member along a bottom edge thereof. Also disclosed is a railing panel support for supporting the panel comprising an upright member sercurable to a base surface and to at least one of the railing panels for supporting the plurality of railing panels in a substantially vertical orientation. The method comprises thermoforming a hand railing into the top edge of a planar sheet around a hand railing mold and thermoforming a bottom rail into the bottom edge of the planar sheet of around a bottom rail mold.

### BACKGROUND OF THE INVENTION

1. Field of Invention

The present invention relates to railings in general and in particular to a method and apparatus for forming a railing having hand and bottom railings thermoformed therein.

2. Description of Related Art

Guard or hand railings are typically located proximate to a periphery of a balcony, deck, as a divisional barrier or along stairs. Such railings typically include a top railing and a barrier portion comprising a plurality of spindles or a barrier sheet of glass, wood or the like.

Conventional railings have several limitations. Railings constructed of metal or wood for the posts, spindles or hand rails restrict the visibility of people attempting to see through them. In addition, railings of a conventional construction need to be cut to size and assembled on site to suit the particulars of the installation. The necessity to assemble the many components of a railing on location is time consuming.

### SUMMARY OF THE INVENTION

According to a first embodiment of the present invention there is disclosed a railing panel comprising an elongate planar member extending between first and second ends defining a panel plane. The railing panel has a top hand railing integrally thermoformed with the planar member along a top edge thereof and a bottom rail integrally thermoformed with the planar member along a bottom edge thereof.

The top railing may comprise a sheet of material continuously formed with the planar member extending out of the panel plane. The top rail may have a material thickness substantially equal to the material thickness of the planar member. The sheet of material of the top railing may form a channel. The channel may have a curved cross section. The top railing may have a question mark shaped cross section. The channel may have a segmented cross section. The bottom rail may comprise a curved sheet continuously formed with the planar member extending out of the panel plane.

At least one of the first and second ends may include a connector for securing the at least one of the first or second ends to an other of the first or second ends of an adjoining planar member. The connector may comprise a lip offset from the plane panel so as to support the other of the first or second ends of an adjacent railing panel when abutted thereagainst.

According to a further embodiment of the present invention there is disclosed a railing system comprising at least one railing panel and a plurality of railing panel supports. The at least one railing panel comprises an elongate planar member extending between first and second ends defining a panel plane. The railing panel further has a top hand railing integrally thermoformed with the planar member along a top edge thereof and a bottom rail integrally thermoformed with the planar member along a bottom edge thereof. The railing panel support comprises an upright member sercurable to a base surface and to at least one of the railing panels for supporting the plurality of railing panels in a substantially vertical orientation.

The upright may have proximate and distal ends wherein the proximate end has a fastening surface securable to a horizontal surface and distal end has a railing connector connectable with the hand railing of the railing panel. The railing connector may comprise an exterior surface sized to be closely received within a corresponding channel within the hand railing.

According to a further embodiment of the present invention there is disclosed a method of forming a railing panel comprising providing a substantially planar sheet of thermoplastic material having top and bottom edges and first and second ends. The method further comprises thermoforming a hand railing into the top edge of the planar sheet around a hand railing mold and thermoforming a bottom rail into the bottom edge of the planar sheet of around a bottom rail mold.

The hand railing and bottom rail may be thermoformed simultaneously around a common mold having the hand railing mold and the bottom rail mold. The common mold may further include a central elongate planar portion between the hand railing mold and the bottom rail mold wherein the common mold further forms a substantially planar central portion on the hand railing. The common mold may further include a curvature having an axis extending between the hand railing and bottom rail molds so as to form a railing panel having a vertically oriented curvature. The hand railing and the bottom rail may be thermoformed independently.

The method may further comprise thermoforming a stepped connector into one of the first or second ends of the sheet. The method may further comprise securing a strip of material along one of the first or second ends of the sheet so as to form a stepped connector therein.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a panel system of the present disclosure applied proximate to a peripheral edge of a deck or balcony.

FIG. 2 is a perspective view of a panel of the system of FIG. 1 according to a first embodiment.

FIG. 3 is a vertical cross sectional view of the panel of FIG. 2 taken along the line 3-3.

FIG. 4 is a horizontal partial cross-sectional view of one edge of the panel of FIG. 2 taken along the line 4-4.

FIG. 5 is a perspective view of a post of the panel system of FIG. 1.

FIG. 6 is a perspective view of a panel of the system of FIG. 1 according to a further embodiment.

### DETAILED DESCRIPTION

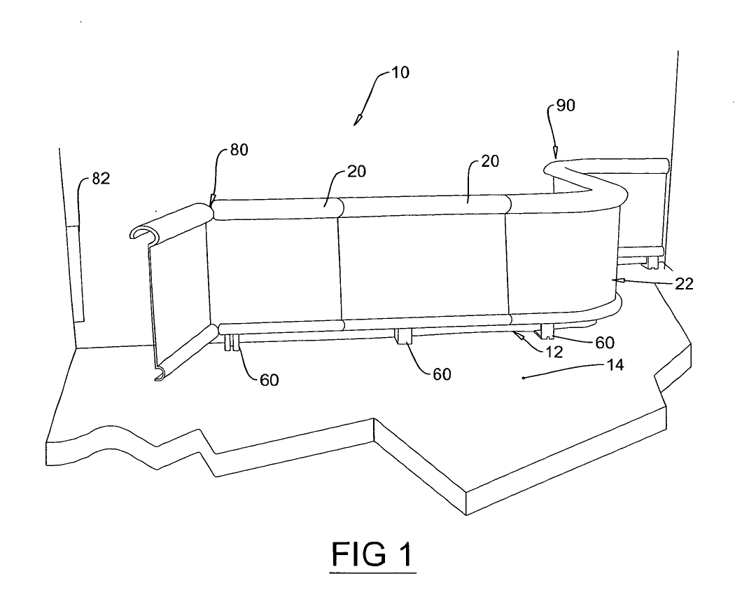

Referring to FIG. 1, a railing system according to a first embodiment of the invention is shown generally at 10. The railing system 10 illustrated in FIG. 1 comprises a plurality of panels 20 supported by a plurality of posts 60 as will be further described below in greater detail. The plurality of panels 20 may be connected together to form a continuous barrier while the posts 60 support the panels. As illustrated, the railing system 10 may be located adjacent to a perimeter edge 12 of a horizontal surface 14 such as a deck or other similar surface to form an edge or other barrier therearound. The railing system 10 may also be located at other locations not proximate to an edge 12 so as to form a barrier at such location.

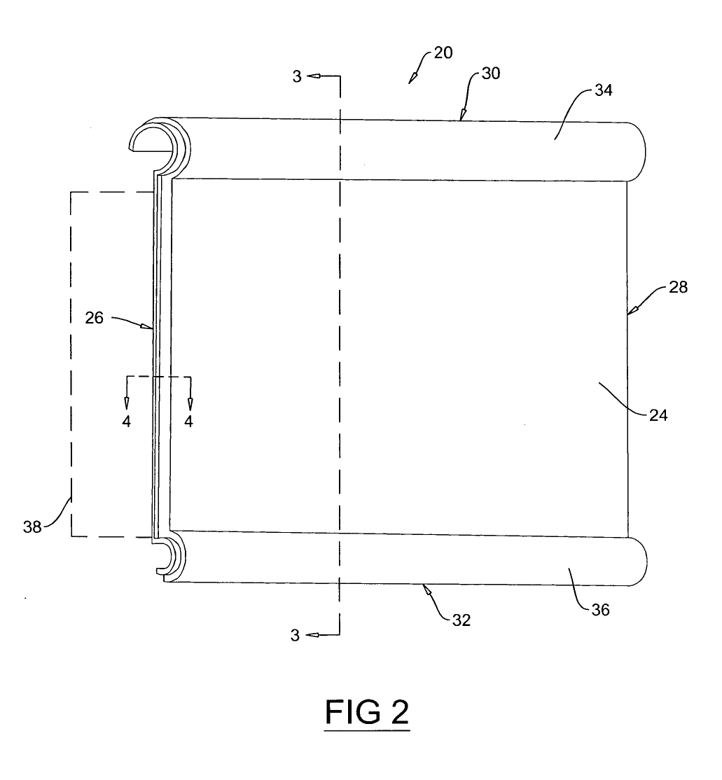

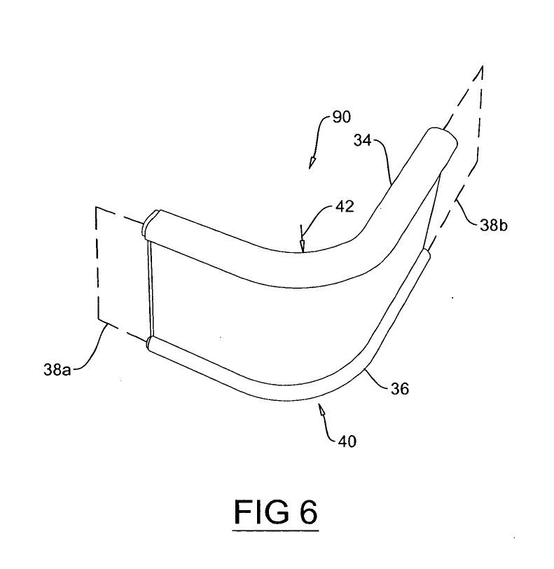

Turning now to FIG. 2, an exemplary panel 20 is illustrated. The panel 20 illustrated in FIG. 2 is a flat panel, however it will be appreciated that curved or corner panels 22 as illustrated in FIGS. 1 and 6 may also be utilized as well. The panel 20 comprises a substantially planar member having first and second ends, 26 and 28, respectively, and top and bottom edges, 30 and 32, respectively. The panel 20 includes a substantially flat planar central portion 24, a hand railing 34 proximate to the top edge 30 and a bottom rail 36 proximate to the bottom edge 32. As illustrated in FIG. 2, the top and bottom edges 30 and 32 are parallel to each other and are perpendicular to the first and second ends 26 and 28 so as to form a panel for use above a horizontal surface. It will also be appreciated that the top and bottom edges 30 and 32 may be angularly oriented away from the first and second ends 26 and 28 for use above a staircase. The panel 20 may have a height selected to suit the needs of a user or as dictated by local regulations. It will be appreciated that the panel 20 will also need to be shorter in a vertical direction for use on a stair case so as to maintain the hand railing 34 at a desired height. The central portion 24 defines a panel plane 38 as illustrated in FIG. 2.

The panel plane 38 is oriented substantially vertically above the horizontal surface 14. Although the panel plane 38 is illustrated as continuous along the length of the panel 20, it will be appreciated that the first and second ends 26 and 28 of the panel 20 may have instantaneous panel planes 38 wherein each instantaneous panel plane 38 may be oriented vertically above the horizontal surface 14 and angularly to each other. In such embodiments, the first end 26 may have a first instantaneous panel plane 38a and the second end 28 may have a second instantaneous panel plane 38b. As illustrated in FIG. 6, the first and second instantaneous panel planes 38a and 38b may be perpendicular to each other with a bend portion 40 therebetween so as to form an angle panel 90. The bend portion 40 may have a radius of curvature, generally indicated at 42, as desired by a user which may be selected from any suitable radius that is aesthetically pleasing or as limited by the equipment utilized to form the panel 20 as described below. By way of non-limiting example, it has been found that a bend portion 40 having a radius of curvature of between 12 and 24 inches has been useful. The angle panel 90 may be manufactured to any required angle such as, by way of non-limiting example 90 degrees as illustrated in the accompanying figures, although it will be appreciated that other angles may be formed as well as desired for aesthetic purposes or as limited by available equipment.

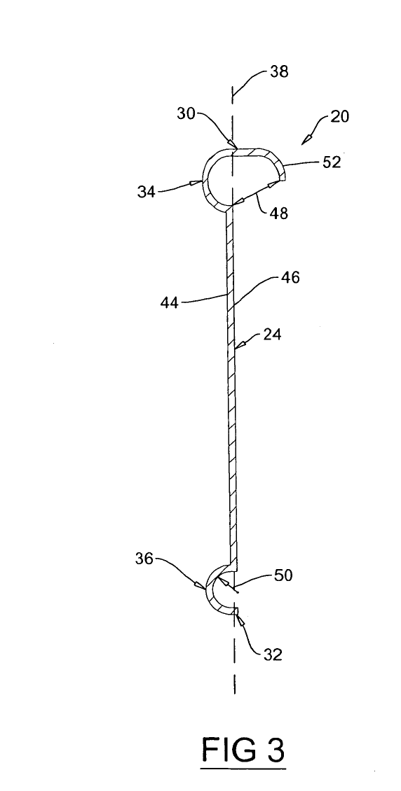

Turning now to FIG. 3, a cross sectional view of the panel 20 is illustrated. As shown in FIG. 3, the panel 20 has front and back surfaces, 44 and 46, respectively, wherein the back surface 46 is oriented towards the perimeter edge 12 of the horizontal surface 14. The hand railing 34 in FIG. 3 comprises a continuous sheet of material with the panel formed into a channel extending from the central portion 24 of the panel. As illustrated, the channel of the hand railing 34 extends the material of the panel 20 out of the panel plane 38 and therefore provides structural rigidity to the panel 20. As illustrated, the hand railing 34 may extend first towards the front surface 44 of the panel 20 and thereafter extend towards the back surface 46 while crossing the panel plane 38. It will also be appreciated that the hand railing may first extend towards the back surface 46 before extending towards the front surface.

The channel of the hand railing 34 may also have a downturned portion 52 at a distal end thereof so as to provide a continuous surface for grasping by the hand of a user. As illustrated in FIG. 3, the channel may comprise a c-shaped channel having a gap, generally indicated at 48, between the end of the downturned portion 52 and the central portion 24 of the panel 20. The gap 48 assists in retaining a post or other support within the channel as will be further described below and may have a distance of 1 inch or greater by way of non-limiting example.

Similarly, the bottom rail 36 comprises a continuous sheet of material with the panel formed into a c-shaped channel extending from the central portion 24 of the panel out of the panel plane 38 so as to provide additional rigidity to the panel. The c-shaped channel of the bottom rail 36 may have a radius of curvature indicated at 50 of between 1 and 2 inches. Although a c-shaped channel is illustrated for the hand railing and bottom rail 34 and 36, it will be appreciated that other shapes may also be useful as well, such as, by way of non-limiting example, ovaloid or a segmented channel such as square, rectangular, hexagonal, octagonal, or triangular.

It will be appreciated that the shape of the hand railing 34 should consist of a shape selected to suit the user without being excessively small so as to provide adequate strength for the panel. The hand railing 34 should also have outer dimensions selected to comply with local regulations or the preferences of a user. In practice, it has been found that an overall width of the hand railing 34 of between 2 and 3 inches has been useful although it will be appreciated that other widths may be useful as well depending upon the application and strength requirements of the panel 20. Similarly, the bottom rail 36 may have a depth out of the panel plane 38 of between ⅞ and 2 inches to provide strength for the panel, although other distances may also be useful as well.

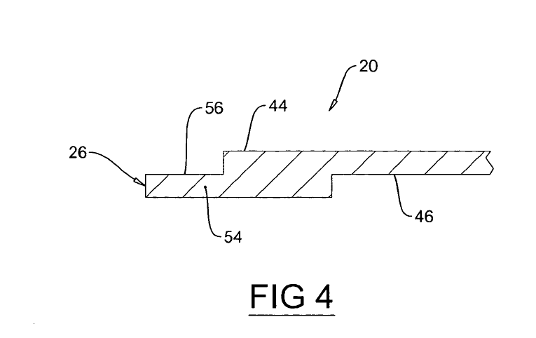

Turning now to FIG. 4, a partial cross-sectional view of the panel 20 is shown illustrating the first end 26 of the panel. The first end 26 includes an offset lip 54 for supporting the second end 28 of an adjacent panel 20. As illustrated, the offset lip 54 includes a front surface 56 substantially aligned with the back surface 46 of the panel 20 such that when an adjacent panel 20 is located thereagainst, the front surfaces of the two panels 20 will be substantially aligned.

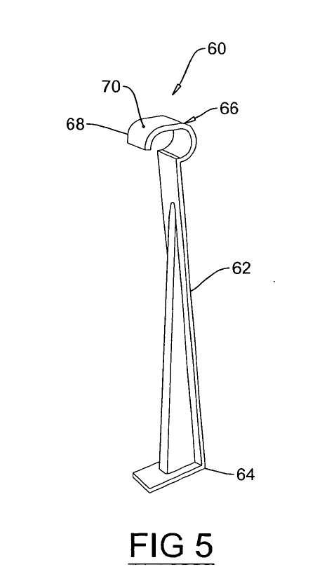

As shown in FIG. 1, the railing system 10 may also include a plurality of posts 60 as shown in greater detail in FIG. 5. The post 60 comprises an upright member 62 having bottom and top ends, 64 and 66, respectively. The bottom end 64 is adapted to be secured to the horizontal surface 14, such as for example a deck, balcony or the like. The top end 66 includes a hand railing holder 68 having an exterior surface 70 therearound. The exterior surface 70 is sized and shaped to be closely received within the channel of the hand railing 34 of the panel 20 so as to retain the hand railing holder 68 within the channel so as to thereby support the panel 20 while allowing for the panel 20 to move horizontally along the railing holder 68 under expansion and contraction of the panel. The post 60 should be sized to support the panel 20 above the horizontal surface 14 at a distance desired by the user or as required by safety regulations. It will be appreciated that the bottom end 64 of the post 60 may be secured to the horizontal surface by lag bolts or the like. Additional material may also be laminated to the bottom end 64 so as to increase the rigidity at the mounting point to reduce the overall material thickness requirements of the remainder of the post 60. As illustrated, the post 60 may include a single rib, however it will be appreciated that other styles of posts may also be utilized, such as, by way of non-limiting example, multiple rib, box or c-shaped channel.

Additional components may be included with the panel 20 and posts 60 as described above to form a continuous barrier around a deck or balcony such as a gate hinge 80 and a wall bracket 82 as illustrated in FIG. 1.

The panel 20 of the present system is formed utilizing a thermoform molding process. Such molding processes are well known and typically include placing a sheet of thermoplastic material above a mold. The sheet of thermoplastic material may then be heated to a pliable forming temperature so as to permit the material to be formed or molded to the mold. The material may be assisted in being formed to the mold by vaccum, gravity or any other known process. The sheet of material utilized for the above process will be a single sheet of material so as to form a panel 20 as a single unit of material.

In forming the panels of the present disclosure, the top edge 30 of the sheet of material is the thermoformed over a hand railing mold so as to form the hand railing 34. The bottom edge 32 is thermoformed over a bottom railing mold to form the bottom rail 36. In some embodiments, the hand railing 34 may be formed first whereas in other embodiments, the bottom rail 36 may be formed first. Still in other embodiments, the hand railing and bottom rail 34 20 and 36 may be formed simultaneously on a common mold having both the hand and bottom railing molds therein. Such a mold may also have a central planar portion adapted to form the central portion 24 of the panel 20 and may also optionally include a curvature adapted to form the bend portion 40 therein as described above. The offset lip 54 may also be thermoformed in the panel 20 simultaneously with the hand railing and bottom rail 34 and 36 or in a separate step. In some embodiments, the offset lip 54 may comprise a strip of material adhered or otherwise secured to the edge of the panel.

The materials utilized in the above process may be of any suitable thermoformable material such as, by way of non-limiting example, polyvinyl chloride (PVC), polyethylene, (PE), polycarbonate, cellulose acetate, acrylonitrile butadiene styrene (ABS), or acrylic. Although the above materials are provided for example purposes only, it will be appreciated that many other materials may also be suitable. The materials utilized to form the panels 20 and posts 60 may also be of any color including transparent such that a user may readily see through the railing of the present system. It will also be appreciated that the materials for use in forming the present railing may also be recycled including through the use of defective or broken panels 20 and posts 60.

While specific embodiments of the invention have been described and illustrated, such embodiments should be considered illustrative of the invention only and not as limiting the invention as construed in accordance with the accompanying claims.

What is claimed is:

1. A railing panel comprising:
an elongate planar member extending between first and second ends defining a panel plane;
a top hand railing integrally thermoformed with said planar member along a top edge thereof; and
a bottom rail integrally thermoformed with said planar member along a bottom edge thereof.

2. The railing panel of claim 1 wherein said top railing comprises a sheet of material continuously formed with said planar member extending out of said panel plane.

3. The railing panel of claim 2 wherein said top railing has a material thickness substantially equal to the material thickness of said planar member.

4. The railing panel of claim 2 wherein said sheet of material of said top railing forms a channel.

5. The railing panel of claim 4 wherein said channel has a curved cross section.

6. The railing panel of claim 5 wherein said top rail has a question mark shaped cross section.

7. The railing panel of claim 4 wherein said channel has a segmented cross section.
thermoforming a hand railing into said top edge of said planar sheet around a hand railing mold; and
thermoforming a bottom rail into said bottom edge of said planar sheet of around a bottom rail mold.

15. The method of claim 14 wherein said hand railing and said bottom rail are thermoformed simultaneously around a common mold having said hand railing mold and said bottom rail mold.

16. The method of claim 15 wherein said common mold further includes a central elongate planar portion between said hand railing mold and said bottom rail mold wherein said common mold further forms a substantially planar central portion on said hand railing.

17. The method of claim 15 wherein said common mold further includes a curvature having an axis extending between said hand railing and said bottom rail molds so as to form a railing panel having a vertically oriented curvature.

18. The method of claim 14 wherein said hand railing and said bottom rail are thermoformed independently.

19. The method of claim 14 further comprising thermoforming a stepped connector into one of said first or second ends of said sheet.

20. The method of claim 14 further comprising securing a strip of material along one of said first or second ends of said sheet so as to form a stepped connector therein.

8. The railing panel of claim 1 wherein said bottom rail comprises a curved sheet continuously formed with said planar member extending out of said panel plane.

9. The railing panel of claim 1 wherein at least one of said first and second ends includes a connector for securing said at least one of said first or second ends to an other of said first or second ends of an adjoining planar member.

10. The railing panel of claim 9 wherein said connector comprises a lip offset from said plane panel so as to support said other of said first or second ends of an adjacent railing panel when abutted thereagainst.

11. A railing system comprising at least one of said railing panels of claim 1 and a plurality of railing panel supports, said railing panel support comprising an upright member sercurable to a base surface and to at least one of said railing panels for supporting said plurality of railing panels in a substantially vertical orientation.

12. The railing system of claim 11 wherein said upright has proximate and distal ends, said proximate end having a fastening surface securable to a horizontal surface, said distal end having a railing connector connectable with said hand railing of said railing panel.

13. The railing system of claim 12 wherein said railing connector comprises an exterior surface sized to be closely received within a corresponding channel within said hand railing.

14. A method of forming a railing panel comprising:
providing a substantially planar sheet of thermoplastic material having top and bottom edges and first and second ends;
